(19) United States
(12) Patent Application Publication
(10) Pub. No.: US 2012/0080633 A1
(43) Pub. Date: Apr. 5, 2012

(54) CONTROL VALVE

(75) Inventor: XIAO-BING XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/006,531

(22) Filed: Jan. 14, 2011

(30) Foreign Application Priority Data
Sep. 30, 2010 (CN) 201010298157.9

(51) Int. Cl. F16K 3/30

(52) U.S. Cl. 251/326

(57) ABSTRACT

A control valve includes a hollow valve body, a valve plug and a block mechanism. The valve body defines a valve chamber, an inlet hole, two outlet holes and two connecting holes. The inlet hole, the two outlet holes and the two connecting holes communicate with the valve chamber, respectively. The valve plug is slidably assembled within the valve chamber of the valve body, and operating in one of three different working states of the control valve. The valve plug defines a first lock slot, an intermediate slot and a second lock slot. The block mechanism is adjustably assembled to the valve body and selectively received and engaged in one of the first lock slot, the intermediate slot or the second lock slot, in which each position of the valve plug establishes one of the three working states of the control valve.

### BACKGROUND

1. Technical Field

The present disclosure relates to control mechanisms, and particularly, to a control valve.

2. Description of Related Art

Control valves are widely applied in many fields such as hydraulic equipment, to control the flow of a liquid or gas. A commonly used control valve often includes two controls, which are switched in use, for controlling the supply to the hydraulic equipment. However, the commonly used control valve has a poor structure and is prone to switch the two controls accidently, thereby generating a potential safety hazard to the hydraulic equipment.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the control valve. Moreover, in the drawings like reference numerals designate corresponding parts throughout the several views. Wherever possible, the same reference numerals are used throughout the drawings to refer to the same or like elements of an embodiment.

FIG. 1 is an assembled isometric view of an embodiment of a control valve.

FIG. 2 is an exploded isometric view of the control valve shown in FIG. 1.

FIG. 3 is a cross sectional view taken along line III-III of FIG. 1.

FIG. 4 is another cross sectional view taken along line IV-IV of FIG. 1.

FIG. 5 is similar to FIG. 4, but shows a second state of the control valve.

FIG. 6 is also similar to FIG. 4, but shows a third state of the control valve.

### DETAILED DESCRIPTION

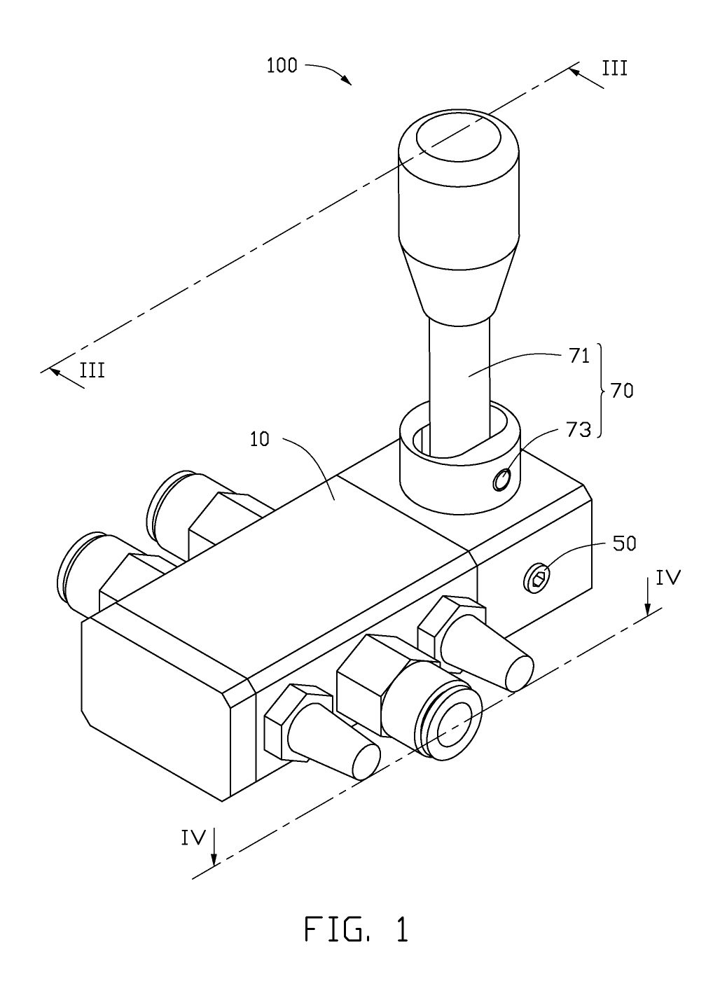

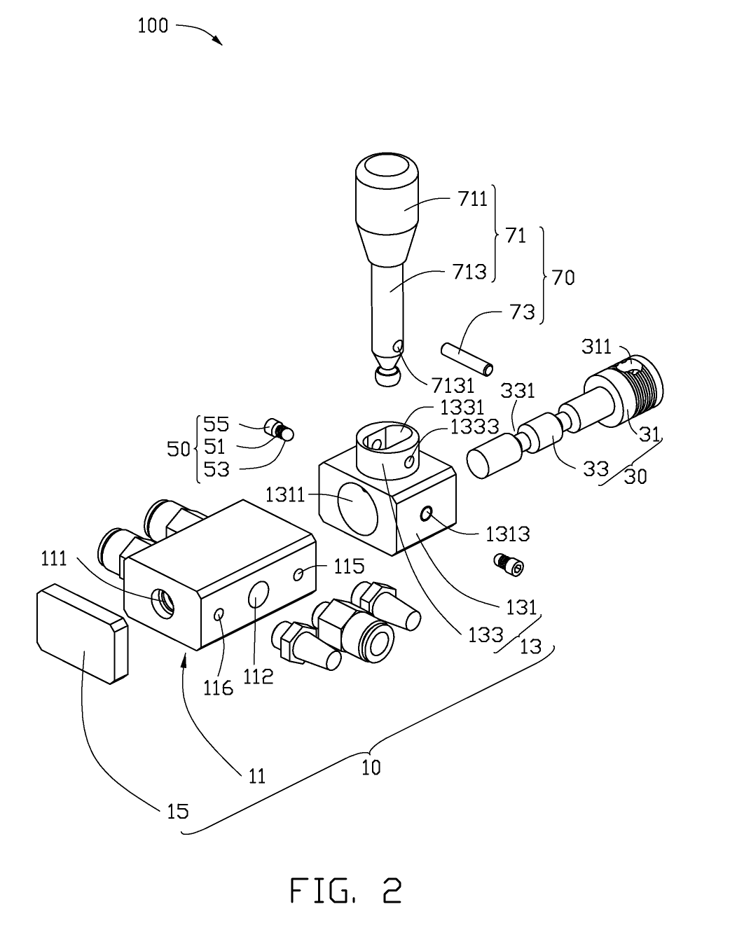

Referring to FIGS. 1 and 2, an embodiment of a control valve 100 includes a valve body 10, a valve plug 30, at least one block mechanism 50, and an operating piece 70. The valve body 10 is hollow. The valve plug 30 is movably or slidably assembled within the valve body 10 and controlled by the at least one block mechanism 50 and the operating piece 70. The at least one block mechanism 50 is adjustably assembled to the valve body 10 and selectively contacts the valve plug 30. In the illustrated embodiment, there are two block mechanisms 50. The operating piece 70 is hinged on the valve body 10 and assembled with the valve plug 30 to control the operation of the valve plug 30.

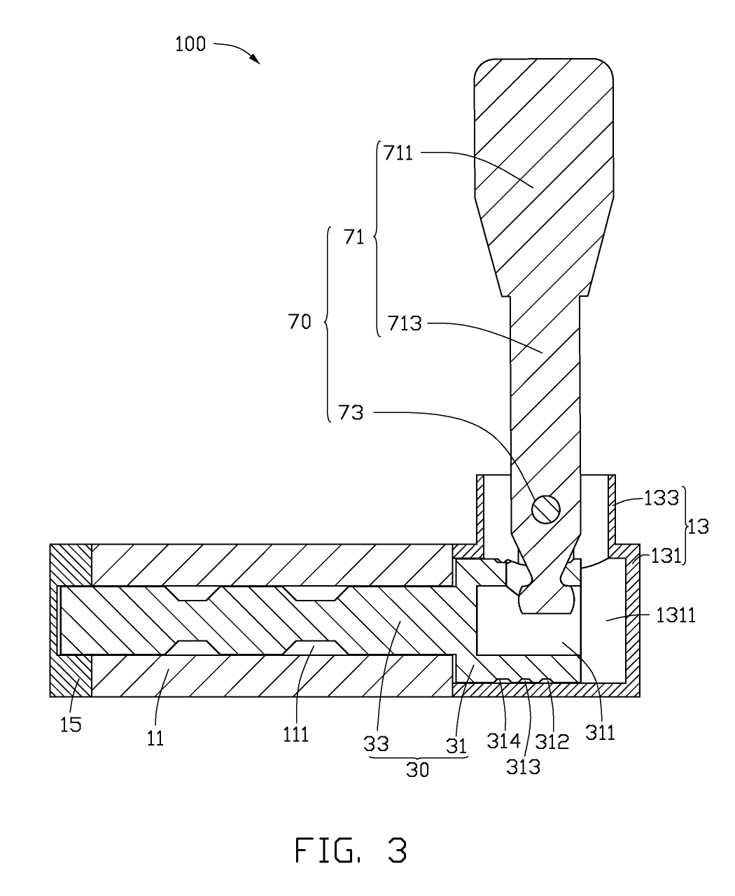

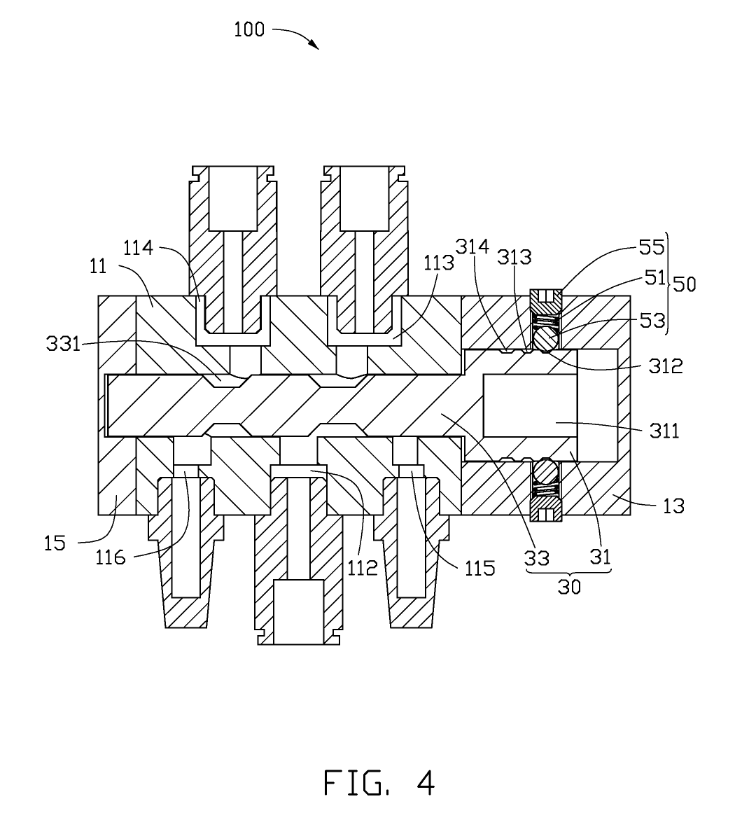

Also referring to FIGS. 3 and 4, the valve body 10 includes a main body 11, a first socket piece 13 detachably assembled to one end of the main body 11 and a second socket piece 15 detachably assembled to the opposite other end of the main body 11. The main body 11 is substantially rectangular. A substantially cylindrical valve chamber 111 is defined through the main body 11 longitudinally. The main body 11 further defines an inlet hole 112 at a substantial center of one sidewall (not labeled) of the main body 11 that communicates with the valve chamber 111. The main body 11 further defines a first outlet hole 115 and a second outlet hole 116, both communicating with the valve chamber 111 and are separately positioned at two sides of the inlet hole 112, respectively. A distance between the first outlet hole 115 and the inlet hole 112 is substantially the same as a distance between the second outlet hole 116 and the inlet hole 112. A first connecting hole 113 and a second connecting hole 114 are separately defined in the opposite sidewall (not labeled) of the main body 11, and both communicate with the valve chamber 111. A distance between the first connecting hole 113 and the second connecting hole 114 is substantially the same as a distance between the inlet hole 112 and the first outlet hole 115, or the distance between the inlet hole 112 and the second outlet hole 116.

The first socket piece 13 includes a main portion 131 and an articulated portion 133 formed on the main portion 131. An accommodating chamber 1311 is defined in one end of the main portion 131 corresponding to the valve chamber 111. The accommodating chamber 1311 is substantially cylindrical and of a diameter exceeding that of the valve chamber 111. As the first socket piece 13 is assembled to one end of the main body 11, the accommodating chamber 1311 is coaxial with the valve chamber 111 of the main body 11. At least one assembly hole 1313 is defined through the main portion 131 to communicate with the accommodating chamber 1311. In the illustrated embodiment, two coaxial assembly holes 1313 are oppositely defined at two sidewalls of the main portion 131. A substantially waist-shaped receiving cavity 1331 is defined through the articulated portion 133 and communicates with the accommodating chamber 1311 perpendicular to the main portion 131. A hinged hole 1333 is defined through the articulated portion 133 to communicate with the receiving cavity 1331. The second socket piece 15 is cover-shaped and assembled to the other end of the main body 11 opposite to the first socket piece 13.

The valve plug 30 is a substantially stepped shaft, and includes a lock portion 31 and a plug portion 33 coaxially connecting with the lock portion 31. The lock portion 31 is cylindrical and of a shape substantially the same as that of the accommodating chamber 1311 of the first socket piece 13. The plug portion 33 is also substantially cylindrical and of a shape substantially the same as that of the valve chamber 111 of the main body 11. A receiving cavity 311 is defined in the lock portion 31 and communicates with the outer periphery of the lock portion 31. A first lock slot 312, an intermediate slot 313 and a second lock slot 314 are separately recessed in from the outer periphery of the lock portion 31. In the illustrated embodiment, the first lock slot 312, the intermediate slot 313 and the second lock slot 314 are all annular, the first lock slot 312 is positioned away from the plug portion 33 end, the second lock slot 314 is positioned toward the plug portion 33 end, and the intermediate slot 313 is positioned between the first lock slot 312 and the second lock slot 314. Two substantially annular plug slots 331 are separately recessed from the outer periphery of the plug portion 33. A distance between the two plug slots 331 is substantially the same as that between the first connecting hole 113 and the second connecting hole 114.

The block mechanism 50 is detachably assembled in the corresponding assembly hole 1313 of the main portion 131, and is configured to be selectively received and engaged in one of the first lock slot 312, the intermediate slot 313 and the second lock slot 314 of the lock portion 31 of the valve plug 30. The block mechanism 50 includes an elastic piece 51, a block piece 53 and a resisting piece 55. In the illustrated embodiment, the elastic piece 51 is a helical spring, and elastically sandwiched between the block piece 53 and the resisting piece 55. The block piece 53 is substantially spherical or semi-spherical. The block piece 53 resists with one end of the elastic piece 51 and is configured to be received in one of the first lock slot 312, the intermediate slot 313 and the second lock slot 314 of the valve plug 30. The resisting piece 55 may be a threaded post adjustably assembled within the assembly hole 1313 of the main portion 131 and resisting the other end of the elastic piece 51.

The operating piece 70 is rotatably assembled to the first socket piece 13 and received in the receiving cavity 311 of the lock portion 31, to drive the valve plug 30. The operating piece 70 includes a handle 71 and a rotary shaft 73. The handle 71 is a substantially stepped shaft, and has an operating portion 711 and a hinge portion 713 coaxially connecting with the operating portion 711. The hinge portion 713 defines a hinge hole 7131 adjacent to one end thereof.

During assembly of the control valve 100, the plug portion 33 is received in and assembled within the valve chamber 111 of the main body 11. The first socket piece 13 is sleeved on the lock portion 31 of the valve plug 30 and coaxially assembled to one end of the main body 11. The lock portion 31 is accommodated within the accommodating chamber 1311, with the receiving cavity 311 thereof aligning with the receiving cavity 1331 of the articulated portion 133. The second socket piece 15 is then coaxially assembled to the other end of the main body 11, such that the main body 11 is coaxially sandwiched between the first and second socket pieces 13, 15. The distal end of the hinge portion 713 aligns with and passes through the receiving cavity 1331, and is received in the receiving cavity 311 of the valve plug 30. The rotary shaft 73 passes through the hinged hole 1333 of the articulated portion 133 and the hinge hole 7131 to rotatably hinge the operating piece 70 to the first socket piece 13. Finally, the two block mechanisms 50 are oppositely assembled in the corresponding two assembly holes 1313 of the first socket piece 13, and the block pieces 53 are correspondingly received in the first lock slot 312 of the lock portion 31 of the valve plug 30 to finish the assembly of the control valve 100.

During use of the control valve 100, the inlet hole 112 of the main body 11 is connected with an inlet duct (not shown), and the first and second connecting holes 113, 114 are respectively connected with an air cylinder (not shown) to intake the gas and exhaust the gas. The control valve 100 has three working states, including a first working state as shown in FIG. 4. The block piece 53 of the block mechanism 50 is received and engaged in the first lock slot 312 of the valve plug 30, and the inlet hole 112 communicates with the first connecting hole 113 via one plug slot 331 of the valve plug 30, such that the gas can be input from the inlet hole 112, and flows into the plug slot 331, and finally enters the air cylinder through the first connecting hole 113. Meanwhile, the second connecting hole 114 communicates with the second outlet hole 116 via the other plug slot 331 of the valve plug 30. Thus, the gas entering into the air cylinder can be output from the second connecting hole 114, and then flows into the other plug slot 331, and is finally vented from the second outlet hole 116.

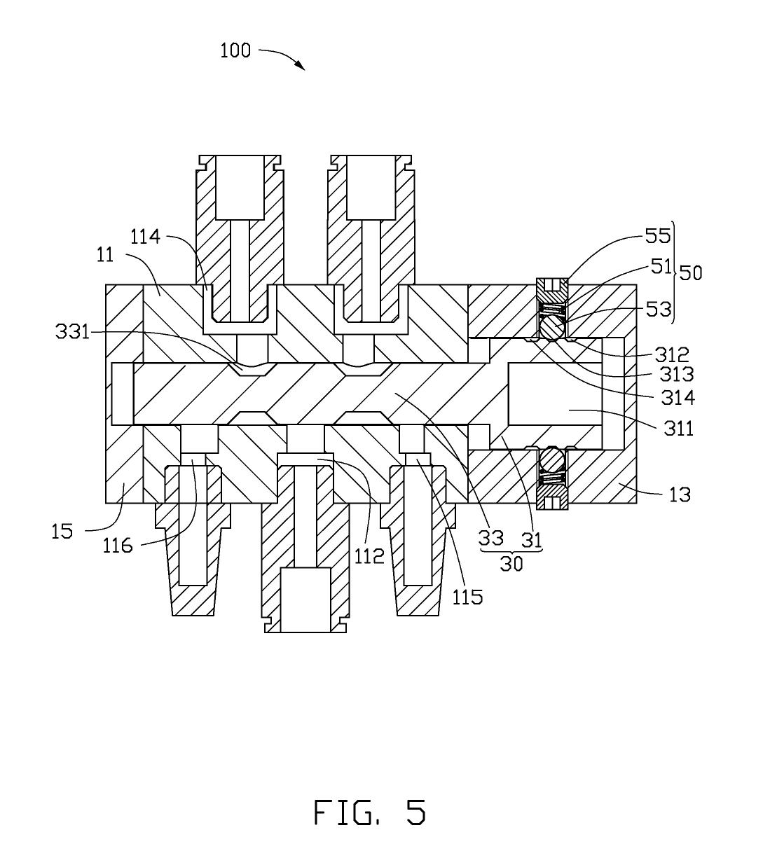

FIG. 5 shows a second working state of the control valve 100. The handle 71 of the operating piece 70 is rotated to drive the valve plug 30 toward the second socket piece 15. The block piece 53 of the block mechanism 50 is detached from the first lock slot 312 and is further received and engaged in the adjacent intermediate slot 313. At this time, the inlet hole 112, and the first and second outlet holes 115, 116 are all closed and cannot communicate with the first and second connecting hole 113, 114. The control valve 100 is thereby in a closed state.

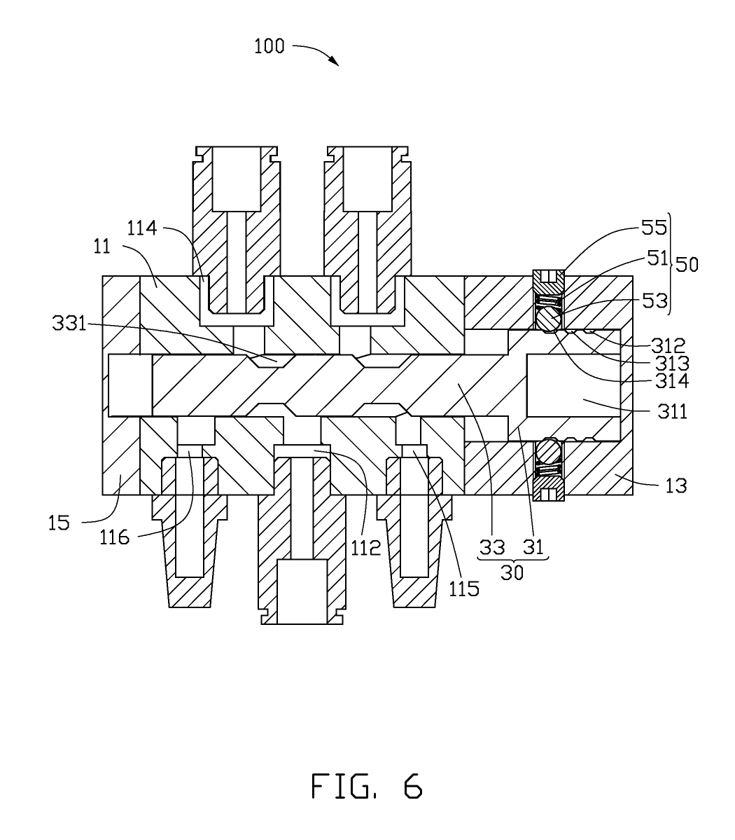

FIG. 6 shows a third working state of the control valve 100. The handle 71 of the operating piece 70 is further rotated to drive the valve plug 30 toward the second socket piece 115, until the block piece 53 of the block mechanism 50 is received and engaged in the second lock slot 314. The inlet hole 112 communicates with the second connecting hole 114 via one plug slot 331 of the valve plug 30, and the first connecting hole 113 communicates with the first outlet hole 115 via the other plug slot 331 of the valve plug 30. The control valve 100 is thus in another working state. The gas is input from the inlet hole 112, and flows into a plug slot 331, and finally enters into the air cylinder from the second connecting hole 114. Meanwhile, the gas entering into the air cylinder is output from the first connecting hole 113, and then flows into the other plug slot 331, and is vented from the first outlet hole 115.

It is to be understood that the operating piece 70 can also be directly assembled to the lock portion 31 of the valve plug 30, thereby directly controlling the valve plug 30.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A control valve, comprising:
a valve body having a valve chamber and further defining an inlet hole, two outlet holes and two connecting holes communicating with the valve chamber, respectively;
a valve plug movably or slidably assembled within the valve body, thereby forming three working states of the control valve; and
a block mechanism,
wherein the valve plug defining a first lock slot, an intermediate slot and a second lock slot, the block mechanism is adjustably assembled to the valve body and selectively engaging with one of the first lock slot, the intermediate slot and the second lock slot, thereby switching between the three working states of the control valve.

2. The control valve of claim 1, wherein the intermediate slot is positioned between the first lock slot and the second lock slot.

3. The control valve of claim 2, wherein the valve body comprises a main body, a first socket piece and a second socket piece, the first and second socket pieces are respectively assembled to two ends of the main body; the first socket piece defines an accommodating chamber coaxially with the valve chamber of the main body, the valve plug is correspondingly received within the valve chamber and the accommodating chamber.

4. The control valve of claim 3, wherein the inlet hole and the two outlet holes are separately defined in one side of the main body; the two connecting holes are separately defined in the other side wall of main body.

5. The control valve of claim 4, wherein the distance between one of the outlet holes and the inlet hole is substantially the same as the distance between the two connecting holes.

6. The control valve of claim 3, wherein the valve plug comprises a lock portion and a plug portion coaxially connecting with the lock portion, the lock portion and the plug portion are respectively received within the accommodating chamber of the first socket piece and the valve chamber of the main body; the plug portion defines two plug slots, and the distance between the two plug slots is substantially the same as the distance between the two connecting holes.

7. The control valve of claim 6, wherein the first lock slot, the intermediate slot and the second lock slot are all annular and separately defined in the lock portion of the valve plug, the first lock slot is positioned away from the plug portion end, and the second lock slot is positioned toward the plug portion end.

8. The control valve of claim 7, wherein the first socket piece further defines an assembly hole communicating with the accommodating chamber; the block mechanism comprises an elastic piece and a block piece, the block piece is elastically assembled in the assembly hole via the elastic piece and selectively contacts and engages one of the first lock slot, the intermediate slot and the second lock slot of the valve plug.

9. The control valve of claim 8, wherein the block mechanism further comprises a resisting piece, the resisting piece is a threaded post adjustably assembled within the assembly hole and resisting the elastic piece.

10. The control valve of claim 8, wherein the control valve further comprises an operating piece, the operating piece is rotatably hinged on the valve body and assembled with the valve plug to control the operation of the valve plug.

11. A control valve, comprising:
a valve body comprising:
a main body defining a valve chamber and further defining an inlet hole, a first outlet hole, a second outlet hole, a first connecting hole and a second connecting hole respectively communicating with the valve chamber; and
a socket piece detachably assembled to one end of the main body and defining an accommodating chamber coaxially with the valve chamber, the socket piece further defining two opposite assembly holes communicating with the accommodating chamber;
a valve plug slidably assembled within the valve body thereby forming three working states with the main body of the control valve, the valve plug defining a first lock slot, an intermediate slot and a second lock slot; and
two block mechanisms adjustably oppositely assembled in two assembly holes of the socket piece and selectively engaging with one of the first lock slot, the intermediate slot and the second lock slot, thereby switching between the three working states of the control valve.

12. The control valve of claim 11, wherein the valve plug comprises a lock portion and a plug portion coaxially connecting with the lock portion, the lock portion and the plug portion are respectively received within the accommodating chamber of the socket piece and the valve chamber of the main body; the plug portion defines two plug slots, and the distance between the two plug slots is substantially the same as the distance between the first and second connecting holes.

13. The control valve of claim 12, wherein the first lock slot, the intermediate slot and the second lock slot are all annular and separately defined in the lock portion of the valve plug, the first lock slot is positioned away from the plug portion end, and the second lock slot is positioned toward the plug portion end.

14. The control valve of claim 13, wherein the socket piece comprises a main portion and an articulated portion formed on the main portion, the accommodating chamber is defined from one end of the main portion, the two assembly holes are defined at two sides of the main portion; the articulated portion defines a receiving cavity communicating with the accommodating chamber; the control valve further comprises an operating piece rotatably assembled to the socket piece, the distal end of the operating piece is received in and assembled to the lock portion of the valve plug.

15. The control valve of claim 13, wherein the block mechanism comprises an elastic piece and a block piece, the block piece is elastically assembled in the assembly hole via the elastic piece and selectively contacts and engages one of the first lock slot, the intermediate slot and the second lock slot of the valve plug.

16. The control valve of claim 15, wherein, at a first working state, the block piece of the block mechanism is engaged into the first lock slot of the valve plug, the inlet hole communicates with the first connecting hole via one plug slot of the valve plug; the second connecting hole communicates with the second outlet hole via the other plug slot of the valve plug.

17. The control valve of claim 15, wherein at a second working state, the block piece is engaged into the adjacent intermediate slot, the inlet hole, the first and second outlet holes are all closed and cannot communicate with the first and second connecting hole, such that, the control valve is in a closed state.

18. The control valve of claim 15, wherein at a third working state, the block piece is engaged into the second lock slot, the inlet hole communicates with the second connecting hole via one plug slot of the valve plug, and the first connecting hole communicates with the first outlet hole via the other plug slot of the valve plug.
